(19) United States
(12) Patent Application Publication
(10) Pub. No.: US 2009/0129623 A1
(43) Pub. Date: May 21, 2009

(54) Speaker Apparatus in a Wireless Communication Device

(75) Inventors: Anders Weckström, Espoo (FI); Leo M. Karkkainen, Helsinki (FI); Timo Avikainen, Helsinki (FI)

Correspondence Address: HARRINGTON & SMITH, PC, 4 RESEARCH DRIVE, Suite 202, SHELTON, CT, 06484-6212, US

(73) Assignee: NOKIA CORPORATION, Espoo (FI)

(21) Appl. No.: 11/920,960

(22) PCT Filed: Jun. 29, 2006
(86) PCT No.: PCT/FI2006/000231

§ 371 Date: Nov. 20, 2007

(30) Foreign Application Priority Data
Jun. 29, 2005 (FI) 20050690

(51) Int. Cl. H04R 1/02

(52) U.S. Cl. 381/386

(57) ABSTRACT

In the invention there is being combined the back cavities of two speakers so that one speaker is used as a general speaker and the other one provides a boosting effect to the general speaker. For example, the other speaker can act as a subwoofer to the general speaker. The back cavity of the speaker is extended by a tubular cavity. The tubular cavity can extend to either the front or back panel of the mobile phone, thereby boosting the other speaker located at the respective panel.

### TECHNICAL FIELD OF THE INVENTION

The present invention concerns a speaker apparatus and furthermore a wireless communication device comprising the speaker apparatus. Yet furthermore the invention concerns a method for enhancing sound quality. Yet furthermore the invention concerns a computer program for enhancing the sound quality.

### BACKGROUND ART

A portable hand-held apparatus such as a mobile phone comprises a speaker arrangement. An acoustic audio technology plays important role for a user of such apparatus. A mobile phone can have an earpiece speaker and an integrated hands free (IHF) speaker. The earpiece speaker and the IHF speaker are basically independently driven in relation to each other. The possibilities to achieve good and clear volume of the sound of the speakers are limited. As a result the sound quality of the mobile phone can be poor. For example, the bass or treble response can suffer and it is not good enough. Furthermore, the sound distortion from the environment may be disturbing, especially in a noisy environment.

Furthermore the design of the mobile phone and placing of speakers in the mobile phone may be a problem. For example, an earpiece speaker should be located very close to an ear of a user when the phone is in use, e.g. close to corner areas in the phone. As a result, proper sealing becomes more difficult and loading of an earpiece speaker increases in order to compensate the possible lack in the sealing. The control of the leakage is important in terms of the 120 dB safety reasons, as is also high enough sound level production for noisy conditions. The achieved subjective sound quality of the earpiece speaker is not the best possible. For example the bass response is not sufficient in the existing earpiece transducers. The pressure to minimize the allowed space for earpiece will be increased even more in the future and simultaneously the need to implement more wideband earpiece transducers is increasing.

The described sound level and quality problems could be avoided in the existing designs by using very large IHF and earpiece speaker components and especially by designing very large surrounding cavity space around them. However the miniaturization trend of the mobile phones, i.e. the hand held apparatuses, sets tight requirements for audio components. Furthermore, it is a known fact that a small moving diaphragm element requires bigger movement to keep the sound pressure level high enough. Bigger movement, in turn, reduces the acceptable sound quality.

### SUMMARY OF THE INVENTION

It is therefore the object of the invention to improve sound quality by widening and/or increasing the frequency response while taking into account the miniaturization trend of the portable hand-held communications apparatuses.

In accordance with a first aspect of the invention there is provided a speaker apparatus of a wireless communication device, the speaker apparatus comprising:

a first speaker comprising a vibrating element and a back cavity surrounding an edge of the vibrating element, and
a second speaker comprising a vibrating element and a back cavity surrounding an edge of the vibrating element; wherein the speaker apparatus further comprises an elongated cavity extending out of the back cavity of the first speaker.

In accordance with a second aspect of the invention there is provided a wireless communication device comprising:

an earpiece speaker configured to produce sound, and
an integrated hands free speaker configured to produce louder sound than the earpiece speaker; wherein
the wireless communication device further comprises means for combining the sound of both speakers so that the other speaker is configured to act as a sub-woofer or provide a sound boost to the another speaker.

In accordance with a third aspect of the invention there is provided a method for enhancing sound quality of a wireless communication device, wherein the wireless communication device comprises a first speaker configured to produce sound and a second speaker configured to produce louder sound than the first speaker; the method comprising:

combining the sound of both speakers so that the other speaker is acting as a subwoofer or providing a sound boost to the another speaker.

In various further embodiments of the invention hands free speaker boosts the earpiece speaker. According to various further embodiments the earpiece speaker can act as a subwoofer to the hands free speaker. In the various further embodiments the back cavity of a speaker is extended by an elongated cavity, for example by a tubular cavity such as a small cross section pipe.

In yet another further embodiments, the elongated cavity can extend to either the front or back panel of the mobile phone, thereby boosting, or acting as a sub-woofer to, the other speaker located at the respective panel.

In various further embodiments, an enhanced audio feature in the mobile phone can be obtained without adding new extra subwoofer component as such. An existing speaker component can act as a subwoofer or sound booster. A critical space within the phone is saved and there is no need to add an extra sub-woofer. Sound quality is enhanced according to various further embodiments. Furthermore in various further embodiments better bass response is obtained. Thus wider and possibly more flat spectrum is obtained.

### BRIEF DESCRIPTION OF THE DRAWINGS

The invention will now be described by way of examples only with reference to the accompanying drawings, in which:

FIG. 1 depicts an earpiece speaker configured to boost an integrated hands free speaker as a subwoofer in accordance with a further embodiment of the invention,

FIG. 2 depicts a sound level response of the integrated hands free speaker in accordance with the further embodiment of the invention,

FIG. 3 depicts a further embodiment of the invention where an earpiece speaker and an integrated hands free speaker operates commonly as a two-way speaker,

FIG. 4 shows a cutaway of the further embodiments, and

FIG. 5 depicts a sound level response of the earpiece transducer in accordance with the further embodiment of the invention.

### DESCRIPTION OF FURTHER EMBODIMENTS

### Earpiece Speaker Acting as a Sub-Woofer for Hands Free Speaker

The general principle in various embodiments relating to the earpiece acting as a sub-woofer to the hands free is to, in contrary to the normal case, use a back volume for the earpiece speaker and a reflex tube such as an elongated cavity. Close to the Helmholtz resonance the speaker membrane displacement is very small and it is thus possible to add low end performance to the main speaker without overstressing the earpiece speaker.

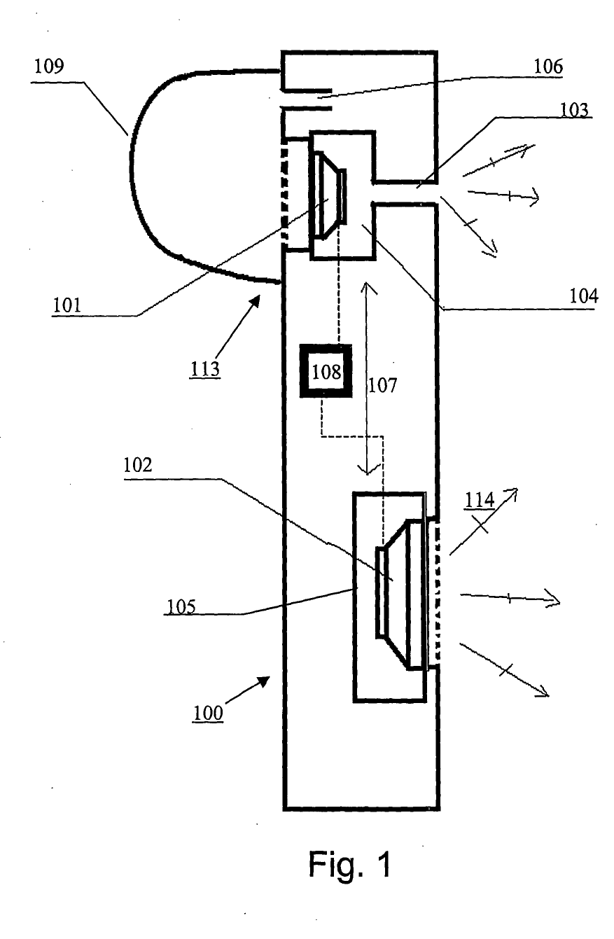

The further embodiment of FIG. 1 depicts an earpiece speaker 101 configured to boost an IHF speaker 102 as a subwoofer. The earpiece speaker 101 can be alternatively referred to as the earpiece transducer or simply as an earpiece.

The further embodiment describes an example how to make the sound quality, for example wider bass response and/or sound level production of a single IHF speaker, better by using the earpiece speaker 101 as a sub-woofer for the IHF 102. The basic characteristics of the earpiece 101 are preferred to be essentially more robust than in known normal use in order to guarantee wider bandwidth requirements. Thus the earpiece speaker 101 works as a subwoofer for the IHF 102. The embodiment can be used for example in the interactive applications like games.

Referring back to the further embodiment of FIG. 1 a mobile phone 100 comprises the earpiece speaker 101. A back cavity 104 surrounds the periphery of the earpiece 101. An ear 109 of the user can be positioned close to or connected to the front cavity (or directly) and further to the earpiece 101. The earpiece 101 can be aimed to produce sound to the front side 113 of the phone 100. It should be noted that in various further embodiments the conception with respect to the front side of the mobile might vary. For example, it can be the same side where the keypad is located or the same side where the earpiece speaker is located. Accordingly it should not be constructed as a limiting the scope.

The mobile 100 comprises further the IHF speaker 102. A back cavity 105 surrounds the periphery of the IHF speaker 102. The IHF speaker 102 can produce louder sound than the earpiece speaker 101 so that the mobile can be operated at a distance “hands free” or even by reaching it with an arm. The IHF speaker 102 can have bigger structure than the earpiece 101. In particularly because the positioning of the IHF 102 in the phone 100 is not so critical as the earpiece (more examples in the following). The IHF 102 can be directed to produce sound to the backside 114 of the phone 100, i.e. back panel. The backside of the phone may also vary depending on the definition. For example, it can be the side where the keypad, IHF speaker, earpiece speaker, etc. is located. Thereby it should not be constructed as limiting the invention.

Referring to the further embodiment of FIG. 1, the earpiece speaker 101 and the IHF speaker 102 work together as a speaker, e.g. a two-way large speaker or the like. Generally the earpiece 101 works as a subwoofer to the IHF speaker 102 in order to make wideband sound better, for example to increase the bass response of the IHF 102. The mobile phone 100 comprises an elongated or a tubular cavity 103, which extends out of the back cavity 104. The tubular cavity 103 can be a pipe to the outside environment of the housing of the mobile phone 100. Advantageously, the tubular cavity 103 extends from the back cavity 104 of the speaker 101 out of the mobile phone 100 to the same side 114, where the IHF speaker 102 is directed to produce sound (as shown in the FIG. 1). It should be noted that the tubular cavity 103 may also extend from the back cavity 104 to the space, which is close to the ear of the user. The space can be closed or open air space. Furthermore the tubular cavity 103 can extend the back cavity 102 next to the IHF speaker 102.

In various further embodiments, the back cavity 104 and the tubular cavity 103 form a resonator. The earpiece speaker 101 is designed to work as close as possible to the resonance frequency of the existing structural Helmholtz resonator when the excursion of the diaphragm is minimized due to the resonance. The resonator comprises the back cavity 104 of the earpiece 101 and the tubular cavity 103 to the outside environment. The tuned resonance frequency of the resonator is lower compared to the resonance of the IHF speaker 102, but the resonator has also certain limits in the low frequencies.

Referring back to the further embodiment of FIG. 1 the earpiece 101 and the IHF 102 can be located at a distance 107 from each other. According to various further embodiments the speakers 101 and 102 are located relatively far away from each other's. The basic characteristics of the earpiece 101 are preferred to be essentially more robust (i.e. larger) than in normal use in order to guarantee the wideband requirements, e.g. the bass response requirements by the bigger excursion of the diagram. At least one leak hole 106 can be alternatively used in various further embodiments to protect the user against high sound levels, e.g. typically higher than 120 dB levels.

In the further embodiment of FIG. 1 the sound quality achieved by an IHF speaker 102 can be better, with the better bass response. Furthermore wider and possible more flat spectrum can be obtained. The sound level can also be increased when used in noisy conditions. This can be implemented in a smaller space compared to a situation where an IHF 102 works alone. This is especially applicable/suitable for small devices.

Furthermore the mobile 100 comprises audio controlling means 108 or the like configured to control the co-operation of the earpiece speaker 101 and IHF speaker 102. For example an audio controller of the mobile phone 100 can contain the audio controlling means 108. The audio controlling means may be implemented by software or by programmable logic, e.g. circuits. The audio controlling means 108 controls the co-operation of the speakers 101 and 102 so that the earpiece speaker 101 is acting as a sub-woofer for hands free speaker 102. In addition the audio controlling means 108 may implement a stereo effect.

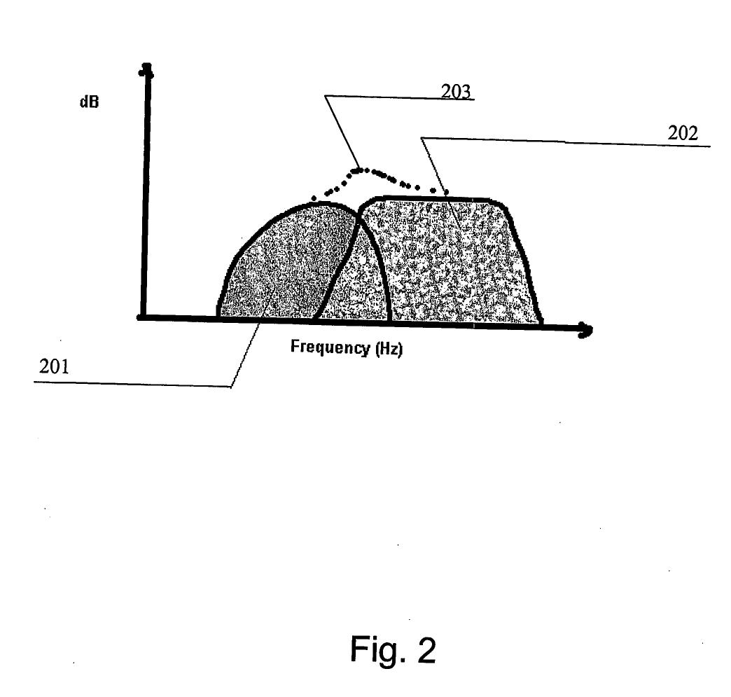

FIG. 2 depicts a sound level response of the IHF speaker 102 of the further embodiment of FIG. 1. Diagram 201 illustrates a sound level response produced by the earpiece 101. Diagram 202 illustrates a sound level response produced by the IHF 102. Thus advantageously an increased bass response of the generated sound level can be seen from diagrams 201 and 202, where the common area yielding to increased bass response as indicated by a dotted line 203 in FIG. 2.

Some further embodiments of the invention require the earpiece speaker to be more performance oriented. This could thus be used in wireless communication devices where the display does not reach all the way to the top edge of the phone. Thereby allowing more flexible earpiece speaker design.

In various further embodiments the properties of speakers can be controlled according to the surrounding environment. Alternatively they can produce together more sound level to the noisy environment or more wide and flat spectra (lower distortion) when extra good sound quality is required. Thus the audio characteristics of the apparatus are controllable. The audio controlling means 108 can be configured to adapted the speaker 101 and 102 to the surrounding environment. Furthermore the mobile phone 100 may contain input or feedback means in order to adapt the speakers 101 and 102 to the surrounding environment.

### Hands Free Speaker Boosting the Earpiece Speaker

Fashion and miniaturization is asking for smaller and smaller earpieces. At the same time the earpiece holes are pushed closer to the upper edge of the phone thus increasing the air pumping capability requirements.

The IHF speaker is generally located at the top of the phone, for example typical in a Nokia monoblock configuration. It is possible to use the output from a reflex tube, e.g. the elongated cavity, from the back volume of the IHF speaker to boost the lacking lower end of the small speaker. Because the boost is provided at frequencies below the Helmholtz resonance of the back volume no adverse effect is caused for the IHF performance.

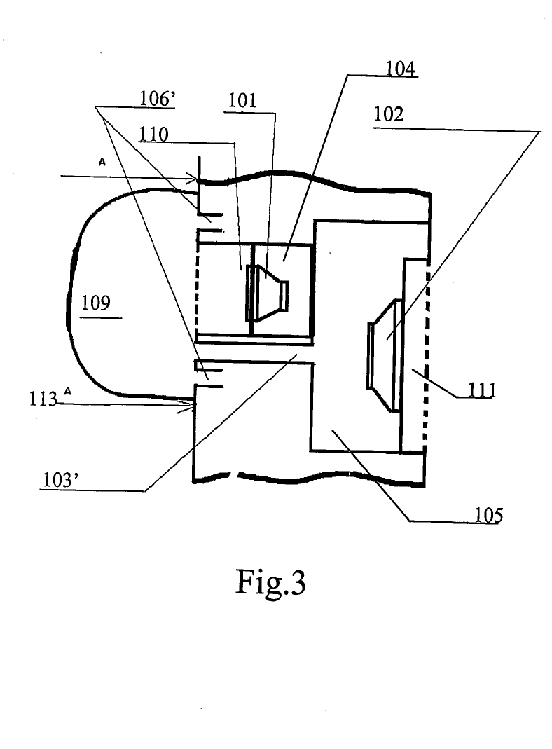

Referring now to a further embodiment of FIG. 3, the earpiece speaker 101 and the IHF speaker 102 operates commonly as a two-way speaker. In the further embodiment, the IHF speaker 102 gives boosting help as a subwoofer for earpiece speaker 101. This can, for example, improve the sound quality in the phones. Thus the earpiece speaker 101 and the IHF speaker 102 work together as a two-way speaker. In various further embodiments they can essentially be located relatively close to each other. However keeping in mind the sizes of the earpiece speaker 101 and IHF speaker 102, which are assumed typical ones, the needed space can be compact making various further embodiments feasible with respect to the location of the speakers within the mobile phone.

A elongated or tubular cavity 103′ connects the IHF cavity 105 to the side of the housing, to which the earpiece speaker 101 is principally designed to produce sound. For example, a small cross section pipe 103′ connects the IHF cavity 105 to the front panel 113 of the earpiece 101. The tubular cavity 103′ can work as a low pass filter to prevent higher frequencies to be transmitted from the IHF 102. In the further embodiment illustrated in FIG. 3, the earpiece speaker 101 and the IHF speaker 102 are located in the opposite sides of a device. However the tubular cavity 103′ connects the IHF 102 to the earpiece 101. In a theory if no leakage would not been involved in a system, the bass response would be in a constant level and independent of the frequency.

It should be noted that in various further embodiments the conception with respect to the front side of a device may also vary. For example, it can be the same side where the keypad is located or the same side where the earpiece speaker is located. Accordingly it should not be constructed as a limiting the scope. The tubular cavity 103′ may also extends from the back cavity 105 to the space, which is close to the ear of the user. The space can be closed or open air space. Furthermore the tubular cavity 103′ can extend the back cavity 105 next to the earpiece speaker 101.

In various further embodiments, the leak holes 106′ can be used close to the earpiece 101 to protect the user against higher than 120 dB sound levels.

The FIG. 3 embodiments relating to the properties of speakers can be controlled according to the surrounding environment. Alternatively they can produce together more sound level to a noisy environment or more wide and flat spectra (lower distortion) when extra good sound quality is required. Thus the audio characteristics of the apparatus are controllable. The audio controlling means 108 can be configured to adapted the speaker 101 and 102 to the surrounding environment. Furthermore the device 100 may contain input or feedback means in order to adapt the speakers 101 and 102 to the surrounding environment. Furthermore the device 100 comprises audio controlling means 108 or the like configured to control the co-operation of the earpiece speaker 101 and IHF speaker 102. For example an audio controller of a mobile phone 100 can contain the audio controlling means 108. The audio controlling means may be implemented by software or by programmable logic, e.g. circuits. The audio controlling means 108 controls the cooperation of the speakers 101 and 102 so that the earpiece speaker 101 is acting as a sub-woofer for hands free speaker 102. In addition the audio controlling means 108 may implement a stereo effect.

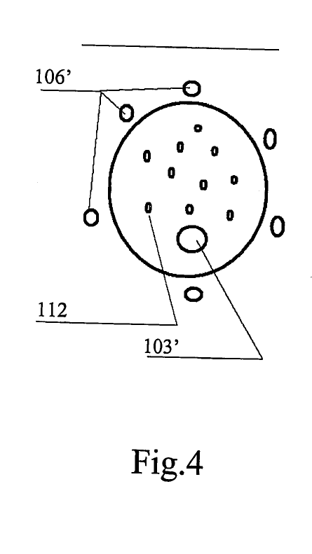

FIG. 4 shows a cutaway of the further embodiments relating to FIG. 3. The tubular cavity 103″ is shown on the front panel of the mobile phone 100. Furthermore the leak holes 106′ are dispersed around the earpiece interface. Holes 112 of the front cavity 110 are dispersed on the panel.

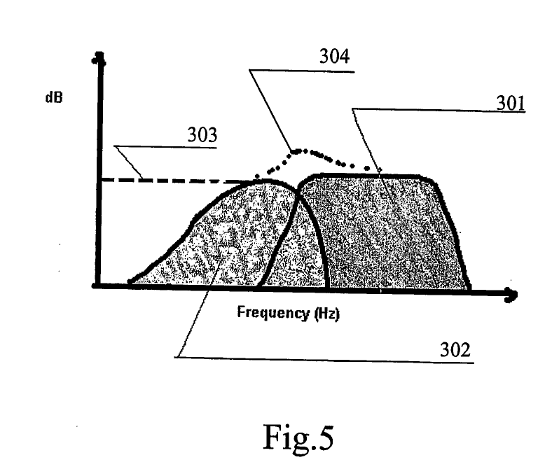

FIG. 5 depicts a sound level response of the earpiece speaker 101 of the embodiments of FIGS. 3 and 4. Diagram 301 illustrates a sound level produced by the earpiece speaker 101. Diagram 302 illustrates a sound level produced by the IHF speaker 302. An increased bass response and, therefore, wider response of the earpiece transducer can be seen from the diagrams 301 and 302. Moreover the common area yielding to increased bass response as indicated by a dotted line 304.

The wireless communication device can be a mobile hand-held terminal operable in mobile communications network. However there are various ways to implement the wireless communication device. The mobile phone 100 is an example of the wireless communication device where the embodiments can be applied.

### Handheld Devices

Handheld devices are usually battery powered and are becoming a usual companion in our day-to-day nomadic activities. Besides some of them, like the cellular mobile phones would easily allow interactive applications since they have the return channel. Examples of handheld devices: Cellular mobile phones. PDAs: they have the advantage to have, generally speaking, bigger screens than mobile phones, however there is a tendency to mix both devices. Portable video-game devices: their main advantage is that the screen is very well prepared for TV applications and that they are becoming popular between e.g. youngsters.

### Portable Devices

Portable devices are those that, without having a small screen, are nomadic and battery powered. As an example: Flat screen battery powered TV set: there are some manufacturers that are presenting such devices, as an example of their use: to allow a nomadic use inside the house (from the kitchen to the bedroom). Portable DVD players, Laptop computers etc. are other examples.

### Ramifications and Scope

Although the description above contains many specifics, these are merely provided to illustrate the invention and should not be constructed as limitations of the invention's scope. It should be also noted that many specifics could be combined in various ways in a single or multiple embodiments. Thus it will be apparent to those skilled in the art that various modifications and variations can be made in the apparatus and processes of the present invention without departing from the spirit or scope of the invention.

1. A speaker apparatus comprising:
a first speaker comprising a vibrating element and a back cavity surrounding an edge of the vibrating element, and
a second speaker comprising a vibrating element and a back cavity surrounding an edge of the vibrating element; characterised in that the speaker apparatus further comprises an elongated cavity extending out of the back cavity of the first speaker.

2. A speaker apparatus according to claim 1, wherein the elongated cavity is configured to provide a subwoofer effect to the second speaker.

3. A speaker apparatus according to claim 2, wherein the first speaker comprises an earpiece speaker and the second speaker comprises a hands free speaker so that the earpiece speaker is configured to operate as a subwoofer to the hands free speaker.

4. A speaker apparatus according to claim 1, wherein the elongated cavity is configured to provide an audio boosting effect to the second speaker.

5. A speaker apparatus according to claim 4, wherein the first speaker comprises a hands free speaker and the second speaker comprises an earpiece speaker so that the hands free speaker is configured to boost the earpiece speaker.

6. A speaker apparatus according to claim 1, wherein the elongated cavity comprises a tubular cavity.

7. A speaker apparatus according to claim 6, wherein the elongated cavity comprises a pipe.

8. A speaker apparatus according to claim 1, wherein the speaker apparatus further comprises controlling means configured to control the co-operation of the first speaker and the second speaker.

9. A speaker apparatus according to claim 8, wherein the controlling means controls an audio boosting effect between the first speaker and the second speaker.

10. A speaker apparatus according to claim 9, wherein the audio boosting effect comprises a subwoofing effect of the elongated cavity.

11. A speaker apparatus according to claim 1, wherein the first speaker and the second speaker are located at a distance from each other so as to produce a stereo effect.

12. A speaker apparatus according to claim 1, wherein the elongated cavity extends from the back cavity of the speaker to an outer surface of a housing of the wireless communication device.

13. A speaker apparatus according to claim 12, wherein the second speaker and the elongated cavity are both configured to produce the sound to generally same side of the wireless communication device.

14. A speaker apparatus according to claim 3, wherein the elongated cavity extends from the back cavity of the earpiece speaker.

15. A speaker apparatus according to claim 1, wherein the elongated cavity connects the back cavity of the first speaker to the back panel of the wireless communication device including such speaker.

16. A speaker apparatus according to claim 1, wherein the elongated cavity is configured to operate as a low pass filter of the sound.

17. A speaker apparatus according to claim 1, wherein the apparatus further comprises at least one leak hole.

18. A speaker apparatus according to claim 17, wherein the leak hole is located next to the speaker in order to attenuate a possible peak sound of the speaker.

19. A speaker apparatus according to claim 1, wherein the elongated cavity is configured to connect the back cavity of the first speaker to the front panel of the wireless communication device including such speaker.

20. A speaker apparatus according to claim 19, wherein the first speaker and the second speaker are located next to each other so that the first speaker is adapted to produce sound towards one side of a wireless communication device including such speaker and the second speaker is adapted to produce sound towards another side of the wireless communication device including such speaker.

21. A speaker apparatus according to claim 19, wherein the elongated cavity and the back cavity of the first speaker are both configured to line the back cavity of the first speaker.

22. A wireless communication device comprising the speaker apparatus according to claims 1.

23. A wireless communication device comprising:
an earpiece speaker configured to produce sound and
an integrated hands free speaker configured to produce louder sound than the earpiece speaker;
means for combining the sound of both speakers so that the other speaker is configured to act as a subwoofer or provide a sound boost to the another speaker.

24. A method for enhancing sound quality of a wireless communication device, wherein the wireless communication device comprises a first speaker configured to produce sound and a second speaker configured to produce louder sound than the first speaker; the method comprising
combining the sound of both speakers so that the other speaker is acting as a sub-woofer or providing a sound boost to the another speaker.

25. A computer program for carrying out the method of claim 24.
